(19) United States
(12) Patent Application Publication
(10) Pub. No.: US 2026/0334729 A1
(43) Pub. Date: Oct. 29, 2026

(54) Coffee Grinder, Coffee Machine And Method To Grind Coffee In A Coffee Grinder

(71) Applicant: WMF GmbH, Geislingen An Der Steige (DE)

(72) Inventors: Armin Startz, Weidenstetten (DE); Sebastian Casado, Lauterstein (DE); Ertugrul Yasar, Elchingen (DE)

(73) Assignee: WMF GmbH, Geislingen An Der Steige (DE)

(21) Appl. No.: 19/122,383

(22) PCT Filed: Feb. 20, 2023
(86) PCT No.: PCT/EP2023/054210

§ 371 Date: Apr. 18, 2025

(30) Foreign Application Priority Data
Oct. 21, 2022 (DE) 10 2022 211 212.1

(51) Int. Cl. A47J 42/46; A47J 31/42; A47J 42/16; A47J 42/18; A47J 42/20

(52) U.S. Cl. CPC A47J 42/46; A47J 31/42; A47J 42/16; A47J 42/20; A47J 42/18

(57) ABSTRACT

A coffee grinder, a coffee machine, and a method for grinding coffee in a coffee grinder are provided. The coffee grinder includes a housing having two parts to provide a maximum stability of the coffee grinder in a minimal installation space. The coffee grinder includes a DC motor, which enables the coffee grinder to provide ground coffee with maximum service life and without any prolonged operating delays in the smallest possible installation space. The coffee grinder can be provided in a coffee machine. A grinding method is provided, which utilizes the coffee grinder or a coffee machine including the grinder.

### CROSS-REFERENCE TO RELATED APPLICATIONS

The present application is a national phase entry under 35 U.S.C. § 371 of International Application No. PCT/EP2023/054210, filed Feb. 20, 2023, which claims priority from German Patent Application No. 102022211212.1 filed Oct. 21, 2022, all of which are incorporated herein by reference.

### FIELD OF THE INVENTION

A coffee grinder, a coffee machine, and a method for grinding coffee in a coffee grinder are provided. The coffee grinder is characterised in that its housing consists of two parts, thus ensuring a maximum stability of the coffee grinder in a minimal installation space. The coffee grinder also has a DC motor. This motor enables the coffee grinder to provide ground coffee with maximum service life and without any prolonged operating delays (e.g. due to coffee powder becoming jammed) in the smallest possible installation space. The coffee grinder can be used in a coffee machine. Furthermore, the coffee grinder or coffee machine can be used in a coffee grinding method, with wherein the same advantages are present for the coffee machine and the method.

### BACKGROUND OF THE INVENTION

Coffee grinders for fully or semi-automatic coffee machines consist of a multipart housing, a bean container on top and a drive consisting of an alternating current (AC) motor or a direct current (DC) motor. The coffee beans are usually ground either by conical grinders or grinding discs. Grinding mechanisms with grinding discs are usually used in cases where high demands are placed on grinding performance and fineness of grind. The coffee beans are ground between two grinding discs arranged in the coffee grinder's housing. One of the two grinding discs remains stationary, the other rotates. Adjusting the distance between the two grinding discs adjusts the fineness of grind (coarser/finer). As a rule, standard motors are used in the drive, which are coupled to the grinding mechanism.

Coffee grinder manufacturers often source the motors for the coffee grinders they produce from third-party manufacturers. The disadvantage here is that, if the third-party manufacturer modifies their motors (e.g. the dimensions), the coffee machine manufacturer must also modify the grinder housing and may need additional components to do so. This means a high expenditure in terms of time and money for the coffee machine manufacturer.

A plurality of coffee grinders are currently operated by AC motors. These have the advantage that they can be supplied with energy directly via the power supply without placing the coffee machine's power supply under strain. However, AC motors have the disadvantage that their starting torque is relatively low. To ensure that even relatively hard coffee beans can be ground, AC motors must be significantly oversized, which means that they are relatively large and require a lot of installation space in the coffee grinder. Another disadvantage of AC motors is their poor efficiency, i.e. they produce high levels of waste heat and experience temperature expansion when in operation.

One advantage of conventional DC motors is that, unlike AC motors, they do not need to be oversized, as they already develop a high torque when starting up and can be operated under overload conditions. The disadvantage, however, is that the power supply unit of the DC motors must be designed correspondingly large to be able to supply the high currents required when starting up. One further disadvantage of operating a motor with a very high starting current under overload conditions is that it shortens the service life of DC motors. Conventional DC motors also have the disadvantage that they do not exhibit stability at high speed frequencies and do not offer any possibility to monitor speed. In addition, conventional DC motors regularly show poor efficiency because high motor speed frequencies require the use of a gear-box. Another disadvantage is that their speed frequency depends on the load. Using such motors in a coffee grinder means that the amount of ground coffee depends on the bean container's fill level as well as on the type of bean.

### SUMMARY OF THE INVENTION

On this basis, the object of the present invention was to provide a coffee grinder, a coffee machine, and a method to grind coffee in a coffee grinder, which no longer has/have at least one of the disadvantages known from the prior art. In particular, the coffee grinder, coffee machine, and method should allow the provision of ground coffee with maximum service life and without any prolonged operating delays (e.g. due to coffee powder becoming jammed) in the smallest possible installation space. The coffee grinder, coffee machine, and method should preferably also enable the provision of high quality ground coffee with a minimal current load, minimal noise pollution, and/or a constistent dosing capacity.

The object is achieved by the coffee grinder having the features of claim 1, the coffee machine having the features of claim 12, and the method having the features of claim 14. The dependent claims show advantageous further embodiments.

According to the invention, a coffee grinder is provided with a two-part housing, which comprises
a) an housing upper part with an interior space suitable for holding coffee beans;
b) a housing lower part, which is connected to the housing upper part and has an interior space suitable for holding a DC motor (preferably a brushless DC motor);
c) an assembly of grinding discs that comprises or consists of a first, upper, non-rotatable grinding disc and a second, lower, rotatable grinding disc, the first grinding disc being arranged opposite the second grinding disc, the coffee grinder being configured to change a distance from the first grinding disc to the second grinding disc; and
d) a DC motor (preferably a brushless DC motor), with a stator, a rotor, and a motor shaft, the motor shaft being connected to the rotor and to the second grinding disc, the stator and rotor being arranged within the interior space of the housing lower part and the motor shaft being arranged within the housing lower part and at least partially within the housing upper part;
wherein the coffee grinder is configured to rotate the second grinding disc relative to the first grinding disc by moving the rotor of the DC motor.

The coffee grinder according to the invention is ideal for providing ground coffee with a maximum service life and without any prolonged operating delays (e.g. due to coffee powder becoming jammed) in the smallest possible installation space.

This is because the grinder housing only consists of two parts, which requires fewer components and connecting elements and thus enables a smaller design and higher long-term stability.

The installation space required is further reduced by arranging the DC motor within the coffee grinder's housing (specifically: in the housing lower part). Furthermore, the speed frequency of DC motors is controllable and is even regulatable when equipping the DC motors with a rotary position sensor. Among other things, DC motors can also turn clockwise and counter-clockwise, thus making it possible to quickly release grinding discs that have become stuck in operation due to coffee residue and to continue operating, thus avoiding longer operating delays due to jammed coffee powder and potentially extending the coffee grinder's service life.

If a brushless DC motor is used instead of a DC motor, this makes the coffee grinder also suitable for providing high quality ground coffee with a minimal current load, minimal noise pollution, an even longer service life, a consistent dosing capacity, and in an even smaller installation space. This motor does not have brushes like conventional DC motors, but is electronically commutated, thus showing less susceptibility to wear and tear as well as being quieter in operation. Furthermore, brushless DC motors are significantly more energy efficient than conventional DC motors and require less installation space (due to the absence of brushes) for the same power output as conventional DC or AC motors. Brushless DC motors also heat up less than conventional DC motors, which can ensure a high quality ground coffee. Furthermore, brushless DC motors inherently have a rotation angle sensor that can be used to regulate their speed frequency. This means, for example, that a possible drop in speed frequency under high load can be quickly readjusted (i.e., compensated for by increasing the motor power), thus ensuring a constant dosing capacity.

The coffee grinder's housing upper part may be connected to the housing lower part via a reversible connection. The reversible connection is preferably selected from the group consisting of frictional connection, form-fit connection, and combinations thereof. Particularly preferred is the reversible connection selected from the group consisting of a clamped connection, a screw connection, a clip connection, a snap hook connection, a connection via a corrugated surface, and combinations thereof. In particular, the reversible connection is a screw-clamp connection via a clamping ring. The advantage of the connection via a clamping ring is that the housing upper part can be rotated 360° relative to the housing lower part. This means that even with the fully assembled coffee grinder, an outlet for the ground coffee (e.g. a through-opening in the upper part of the coffee grinder's housing) can still be flexibly turned in the desired direction. This can be an advantage, for example, if a coffee machine has two coffee grinders according to the invention and the outlet for ground coffee for both grinders has to be adjusted to an inlet of the coffee machine's brewing group. This adjustment can thus be made more quickly and easily.

The coffee grinder may have a through-opening from an interior space in the coffee grinder to an exterior space of the coffee grinder and may be configured to convey ground coffee through the through-opening (i.e. the coffee grinder may have an outlet for ground coffee). The through-opening is preferably arranged in the upper part of the housing. Furthermore, the through-opening is preferably connected to a conduit, wherein the conduit is optionally connected to the upper housing part by a connection selected from the group consisting of a plug connection, a screw connection, and combinations thereof. The conduit can make it easier to adjust or direct the ground coffee's outlet into an inlet of a brewing group of a coffee machine or into a porta-filter for a coffee machine.

To support the motor shaft, the coffee grinder may have a bearing element in the lower part of the housing.

The bearing element preferably has an external thread via which it is screwed to the housing lower part, the external thread preferably has a pitch in the range of 0.2 mm to 1.0 mm, particularly preferably 0.3 mm to 0.8 mm, very particularly preferably 0.4 mm to 0.6 mm, in particular 0.5 mm. A pitch in this range has been found to be advantageous for finely adjusting the distance between the second and first grinding disc, i.e., it is advantageous for finely adjusting the grinding degree.

In an advantageous embodiment, the bearing element is connected to a variable displacement motor, preferably via a gear wheel that engages with a pinion of the variable displacement motor. The variable displacement motor is particularly configured to change the position of the bearing element and the motor shaft mounted therein towards the motor shaft's longitudinal axis. Optionally, the variable displacement motor can be comprised by the coffee grinder or comprised by a coffee machine with the coffee grinder according to the invention. In principle, as a conceivable alternative to this preferred embodiment, the bearing element's position and the motor shaft mounted therein can be changed in the direction of the motor shaft's longitudinal axis without the aid of a user, for example by a user manually turning the bearing element. The motor shaft of the DC motor is preferably configured to change a position in the direction of the motor shaft's longitudinal axis. As the motor shaft is connected to the second grinding disc, the configuration to change the position in the direction of the motor shaft's longitudinal axis is effectuates the advantage that a distance between the second grinding disc and the first grinding disc (and thus a fine grind setting of the coffee beans) can be adjusted by moving the motor shaft axially. To make this possible, the motor shaft is preferably connected to a bearing element of the motor shaft mount, preferably in an area of the motor shaft arranged in the housing lower part, whereby a variable displacement motor for the coffee grinder, or a variable displacement motor of a coffee machine which comprises the coffee grinder, is configured to cause, by rotating its rotor, a change in the position of the bearing element and of the motor shaft mounted therein towards the motor shaft's longitudinal axis.

Furthermore, the motor shaft can be connected to the rotor of the DC motor in an area of the motor shaft arranged in the housing lower part, with the DC motor being configured to cause the motor shaft to rotate around the motor shaft's longitudinal axis by rotating its rotor.

Apart from that, the motor shaft can be connected to the second (i.e. the lower, rotatable) grinding disc via a grinding disc carrier, preferably in an area of the motor shaft that is located inside the housing upper part. The advantage of using the grinding disc bracket to connect the motor shaft to the second grinding disc is that it simply and cost-effectively enables the establishment of a power-transmitting connection between the motor shaft and the second grinding disc. For example, when replacing the second grinding disc, the grinding disc does not need to be adjusted to the motor shaft geometry. The relatively direct connection between the second grinding disc and the motor shaft via the grinding disc bracket also improves the second grinding disc's concentricity and axial run-out compared to coffee grinders with multiple adapters and drivers. Improving the concentricity and axial run-out can ensure that the fine grind setting remains as consistent as possible while the coffee grinder is in operation.

The first grinding disc and/or the second grinding disc can comprise or consist of a material selected from the group consisting of metal, ceramic, and combinations thereof, preferably a material selected from the group consisting of steel, ceramic, and combinations thereof, in particular a material selected from the group consisting of X210CrW12 steel and Al2O3 ceramic. Furthermore, the first grinding disc and/or second grinding disc can have an external diameter ranging from 30 to 80 cm, preferably 55 to 70 cm, in particular 65 cm.

In addition, the first grinding disc and/or second grinding disc can be arranged in the housing upper part.

The coffee grinder may have an infeed element (for coffee) located in the housing upper part. The infeed element may have a spindle with a spindle axis. The infeed element is preferably configured to rotate (around its spindle axis) and, in doing so, to transport coffee beans to the grinding disc arrangement. The advantage of this is that the coffee beans are evenly fed into the grinding disc arrangement, which ensures a more consistent grinding result (e.g. in terms of the amount ground and/or the fine grind setting). The infeed element may have a protective guard configured to prevent reaching into the interior of the housing upper part. This can help prevent potential injury to the coffee grinder's user. The infeed element is preferably connected to the second, lower, rotatable grinding disc. This means that the infeed element can be rotated by rotating the second grinding disc, i.e. the infeed element can rotate with the second grinding disc. The infeed element is preferably screwed to the motor shaft (and the second, lower, rotatable grinding disc).

The second, lower, rotatable grinding disc and the grinding disc bracket may be one piece. In this case, replacing the second grinding disc would also involve replacing the grinding disc bracket.

In an advantageous embodiment, the second lower rotatable grinding disc is connected to a grinding disc bracket, preferably via a connection selected from the group consisting of a frictional connection, a form-fit connection, and combinations thereof, wherein the connection is in particular a screw connection. The advantage of this design is that the grinding disc bracket does not need to be replaced when the second grinding disc is being replaced. This saves material and costs and is therefore more economical and ecological.

The DC motor may be equipped with a brush or a brushless DC motor. The advantage of a brushless DC motor is that it already has a rotary position sensor. This can be used to regulate its speed frequency, ensuring that the coffee grinder's dosing capacity remains consistent. Furthermore, since there are no brushes to conduct electricity, a brushless DC motor generates less heat during operation than a conventional DC motor, thus ensuring a higher quality of ground coffee. As there is no carbon in the brushless DC motor, the current load is lower and the service life longer (because, due to the brushes, there are no frictional losses). In addition, the brushless DC motor allows for quieter operation (as there is no noise from rubbing carbon) and a more compact coffee grinder design (as there is no carbon to take up space).

The preferred DC motor is a DC motor without a housing, optionally a DC motor equipped with brushes but without a housing, or a brushless DC motor without a housing. One advantage of the DC motor without a housing is that a coffee grinder manufacturer purchasing the (optionally also brushless) DC motor without a housing from a third-party manufacturer is no longer dependent on the manufacturer's specific motor housing shape, which is also subject to change. This increases the coffee grinder manufacturer's flexibility and reduces his manufacturing costs. Furthermore, an (optionally brushless) DC motor without housing takes up less space than an (optionally brushless) DC motor with housing, which can further reduce the installation space required for the coffee grinder. This is because in this embodiment, the housing lower part (and at least some areas of the housing upper part) of the coffee grinder according to the invention can represent the (only) housing of the housing-less DC motor.

The DC motor can have a wattage ranging from 50 to 500 watts. A wattage in this range has proven to be advantageous for grinding coffee.

In a preferred embodiment, the DC motor has a height ranging from 25 to 70 mm, particularly preferably 35 to 45 mm, in particular 40 mm, and/or a diameter ranging from 50 to 120 mm. These dimensions allow the provision of a very compact coffee grinder.

The coffee grinder, preferably the coffee grinder's DC motor, can have a control unit. The control unit is configured to control or regulate the speed frequency of the DC motor. Furthermore, the control unit can be configured to control or regulate the direction in which the DC motor's rotor rotates. For regulation purposes, the DC motor must have a rotary position sensor.

In a preferred embodiment, the DC motor thus has a rotary position sensor, wherein the rotary position sensor is preferably selected from the group consisting of an optical rotary position sensor, a magnetic rotary position sensor and combinations thereof, wherein the rotary position sensor particularly preferably comprises or consists of a Hall sensor and/or GMR sensor. The advantage of the rotary position sensor is that it enables control of DC motor speed frequency, which means that it can quickly compensate for a possible drop in speed frequency due to a high load, thus ensuring that the coffee grinder has a consistent dosing capacity.

Preferably, a control unit for the coffee grinder, preferably a control unit for the coffee grinder's DC motor, is configured to control a DC motor speed frequency based on at least one signal from the rotary position sensor.

Additionally, it is preferred that a control unit for the coffee grinder, preferably a control unit of the coffee grinder's DC motor, is configured to control or regulate in which direction the rotor of the DC motor rotates based on at least one signal from the rotary position sensor. By controlling the direction of rotation, the first and second grinding discs can be prevented from getting stuck in coffee beans or coffee grounds (i.e. a possibly blocking the grinder), so that the coffee grinder can continue to operate.

It is therefore preferred that a control unit of the coffee grinder, preferably a control unit of the coffee grinder's DC motor, is configured to detect a blockage in the DC motor based on at least one signal from the rotary position sensor and, in the event a blockage is detected, to reverse the direction in which the DC motor rotates for a specific period of time, in particular 1 to 5 seconds, and/or for a specific degree of rotation, in particular 0.25 to 10 revolutions.

In a further preferred embodiment, a control unit of the coffee grinder, preferably a control unit of the coffee grinder's DC motor, is configured to detect a grinding point of the first grinding disc on the second grinding disc based on at least one signal from the rotary position sensor and, in the event of detecting a grinding point, to define this as a coffee grinder setting for the finest degree of grinding. To detect the grinding point, it is preferred that, in addition to the at least one signal from the rotary position sensor, a DC motor's current consumption is also taken into account, whereby a grinding point is detected either by a drop in a speed frequency at a constant current consumption or by an increase in a current consumption at a constant speed frequency.

The upper and/or lower part of the coffee grinder housing may have a wall thickness of between 1 and 5 mm at least in some areas.

The coffee grinder's housing upper part and/or the housing lower part may comprise or consist of a material selected from the group consisting of metal, plastic, and combinations thereof, preferably a material selected from the group consisting of die-cast aluminium, die-cast zinc, steel, plastic, and combinations thereof.

Furthermore, the coffee grinder's housing upper part and/or housing lower part may have a height ranging of between 50 and 150 mm, at least in some areas.

Apart from that, the coffee grinder's upper housing part and/or lower housing part may have a diameter ranging between 50 and 150 mm, at least in some areas.

Additionally, the coffee grinder's upper housing part and/or lower housing part can have the shape of a hollow cylinder at least in some areas.

A sensor element for detecting a degree of grinding can be arranged at the base of the lower part of the coffee grinder's housing. This sensor element is configured to detect a distance between the sensor element and a bearing element for mounting the DC motor's motor shaft.

A control unit of the coffee grinder according to the invention, or of a coffee machine comprising the coffee grinder according to the invention, can be configured to determine a degree of grinding of the coffee grinder according to the invention (or of the coffee) from information of the sensor element.

According to the invention, a coffee machine is also provided which comprises a coffee grinder according to the invention. The coffee machine is preferably a semi-automatic or fully automatic coffee machine.

The DC motor of the coffee machine's coffee grinder can have a rotary position sensor, preferably a rotary position sensor selected from the group consisting of an optical rotary position sensor, magnetic rotary position sensor, and combinations thereof, wherein the rotary position sensor particularly preferably comprises or consists of a Hall sensor and/or GMR sensor. A control unit for the coffee grinder and/or coffee machine can be configured to regulate the DC motor speed frequency based on at least one signal from the rotary position sensor.

Furthermore, a control unit of the coffee grinder and/or coffee machine can be configured to control in which direction the rotor of the DC motor rotates.

Furthermore, a control unit of the coffee grinder and/or coffee machine can be configured to detect a blockage of the DC motor and, in the event that a blockage is detected, to reverse a direction in which the DC motor rotates for a specific period of time, in particular 1 to 5 seconds, and/or for a specific degree of rotation, in particular 0.25 to 10 rotations.

Apart from that, a control unit of the coffee grinder and/or coffee machine can be configured to detect a grinding point of the first grinding disc on the second grinding disc and, in the event a grinding point is detected, to define this as a setting for the coffee grinder's finest grind, wherein, for detecting the grinding point, in addition to the at least one signal from the rotary position sensor, optionally also a DC motor's current consumption is taken into account, wherein a grinding point is optionally detected either by a drop in a rotational speed frequency at constant current consumption or by an increase in a current consumption at a constant speed frequency.

According to the invention, a method for grinding coffee in a coffee grinder is also provided, comprising the steps:
a) Providing a coffee grinder, or coffee machine, according to the invention;
b) filling the upper part of the coffee grinder housing with coffee beans or coarsely ground coffee; and
c) grinding the coffee beans or coarsely ground coffee.

In the method, the coffee grinder's DC motor can have a rotary position sensor, preferably a rotary position sensor selected from the group consisting of an optical rotary position sensor, magnetic rotary position sensor, and combinations thereof, wherein the rotary position sensor particularly preferably comprises or consists of a Hall sensor and/or GMR sensor. In the method, a DC motor speed frequency can be controlled based on at least one signal from the rotary position sensor.

Furthermore, the method can be used to control in which direction the rotor of the DC motor rotates based on at least one signal from the rotary position sensor.

Furthermore, in the method, a blockage in the DC motor can be detected based on at least one signal from the rotary position sensor, and, in the event a blockage is detected, the direction in which the DC motor rotates can be reversed for a specific period of time, in particular 1 to 5 seconds, and/or for a specific degree of rotation, in particular 0.25 to 10 revolutions.

Apart from that, the method enables the detection of a grinding point of the first grinding disc on the second grinding disc, based on at least one signal from the rotary position sensor, and, in the event a grinding point is detected, the grinding point can be defined as a setting for the coffee grinder's finest grind, wherein, for detecting the grinding point, in addition to the at least one signal from the rotary position sensor, a DC motor's current consumption is also optionally taken into account, wherein a grinding point is optionally detected either by a drop in a rotational speed frequency at a constant current consumption or by an increase in a current consumption at a constant speed frequency.

The above-mentioned method steps can be performed by a control unit of the DC motor, by a control unit of the coffee grinder, or by a control unit of the coffee machine.

### BRIEF DESCRIPTION OF THE DRAWINGS

The subject matter in accordance with the invention will be explained in more detail with reference to the following Figures without intending to restrict it to the specific embodiments shown here.

FIG. 1: Inside view of the coffee grinder showing upper and lower housing parts, including the clamping ring and infeed element of the present disclosure.

FIG. 2: Cross-sectional view showing the grinding disc arrangement, DC motor, and control elements of the present disclosure.

FIG. 3: Assembly view of parts forming the coffee grinder of the present disclosure.

FIG. 4A-B: Show a connection between the housing upper housing to the housing lower part via a clamping ring for an aspect of a coffee grinder design according to the invention.

### DETAILED DESCRIPTION

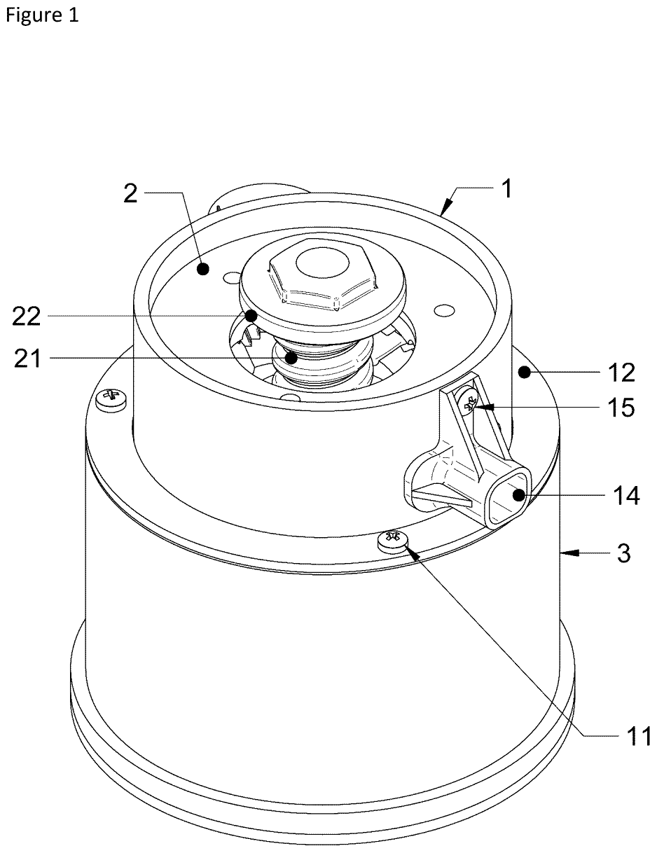

FIG. 1 schematically shows the inside of a specific coffee grinder design according to the invention. The coffee grinder comprises a housing upper part 1 with an interior space 2 that is configured to hold coffee beans, and a housing lower part 3 that is connected to the housing upper part 1. In this design, it can be seen that the housing upper part 1 is connected to the housing lower part 3 by a screw-clamp connection 11 via a clamping ring 12. The clamping ring 12 allows the housing upper part 1 to be rotated 360° relative to the housing lower part 3. The arrangement of the infeed element 21 with its protective guard 22 is also illustrated here. The infeed element 21 is used to feed coffee (beans) and fixes the first grinding disc 5 to the coffee grinder's housing upper part 1. The protective guard prevents users from accidentally accessing the interior space 2 of the housing upper part 1 and can thus prevent a potential user injury. The housing upper part 1 has a through-opening through it that is connected to a conduit 14. The conduit 14 is attached to the housing upper part 1 via a screw connection 15.

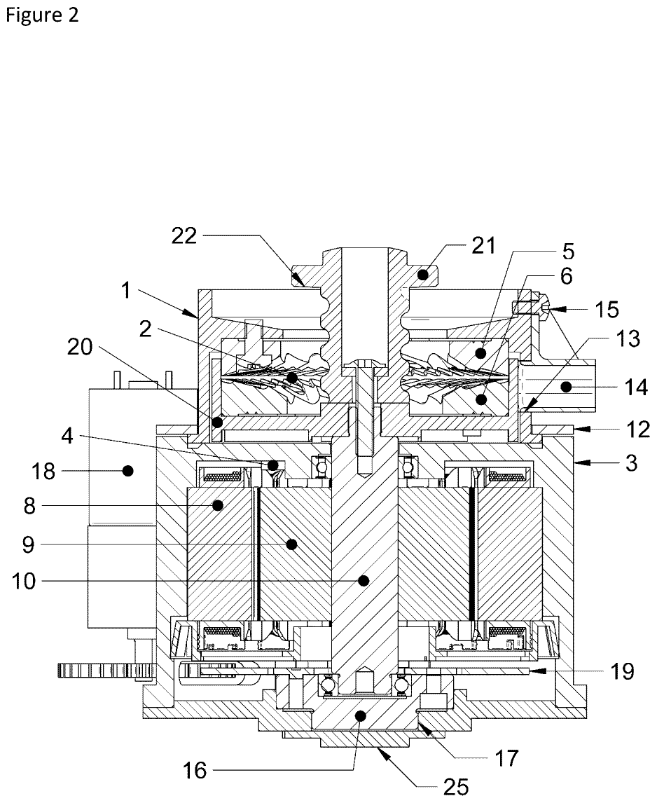

FIG. 2 schematically shows a cross-section of a specific coffee grinder design according to the invention and shows further parts of the coffee grinder in addition to the parts shown in FIG. 1. For example, the interior space 4 of the coffee grinder's housing lower part 3 is shown in more detail here. It can be seen that the coffee grinder comprises a grinding disc arrangement which consists of a first, upper, non-rotatable grinding disc 5 and a second, lower, rotatable grinding disc 6, the first grinding disc 5 being arranged opposite the second grinding disc 6. The coffee grinder is configured to change the distance between the first grinding disc 5 and the second grinding disc 6. In addition, the coffee machine includes a brushless DC motor, which has a stator 8 and a rotor 9, the rotor 9 being connected to the second grinding disc 6. The coffee grinder is configured to rotate the second grinding disc 6 relative to the first grinding disc 5 by moving a rotor 9 of the brushless DC motor, which is transmitted to the motor shaft 10. It can also be seen that the motor shaft 10 is connected to a bearing element 16 for mounting the motor shaft 10 via a press fit. The bearing element 16 has an external thread 17, via which it is screwed to the housing lower part 3. Furthermore, the bearing element 16 is connected to a gear wheel 19 which engages in a pinion (not shown) in the variable displacement motor 18. The variable displacement motor 18 can be used to move the bearing element 16 and thus the motor shaft 10 in one direction along the longitudinal axis of the motor shaft 10 and thus to move the second grinding disc 6, which is connected to the motor shaft 10 via a grinding disc bracket, towards the first grinding disc and away from it (i.e., to change the coffee's grinding fineness). In this design, a sensor element 25 is arranged at the bottom of the housing lower part 3 to detect the fine grind setting. This sensor element is configured to detect the removal of the sensor element 25 from a bearing element 16. The fine grind setting of the coffee grinder (or the coffee) can be derived from this distance information.

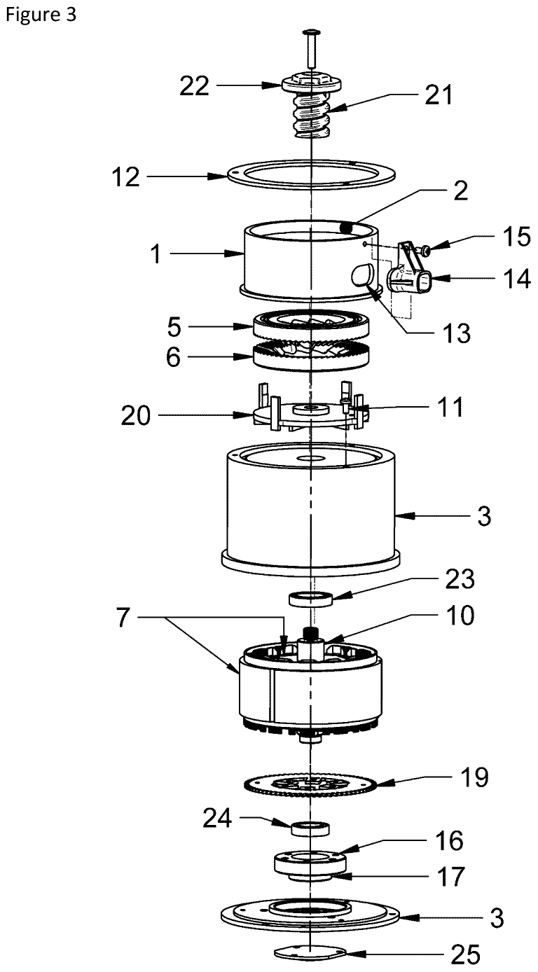

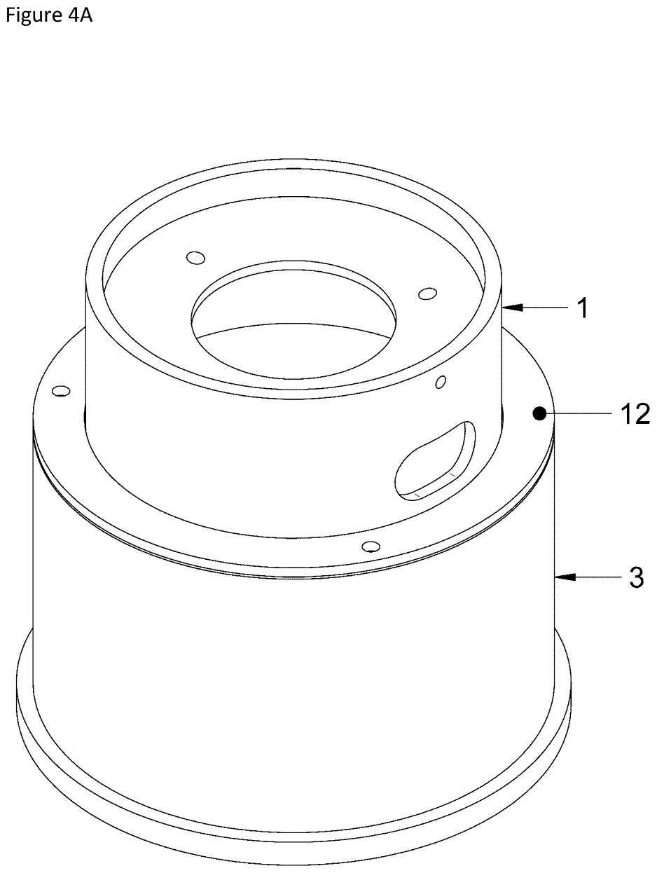

FIG. 3 schematically shows individual parts of a specific coffee grinder design according to the invention and how they are assembled into a complete coffee grinder.

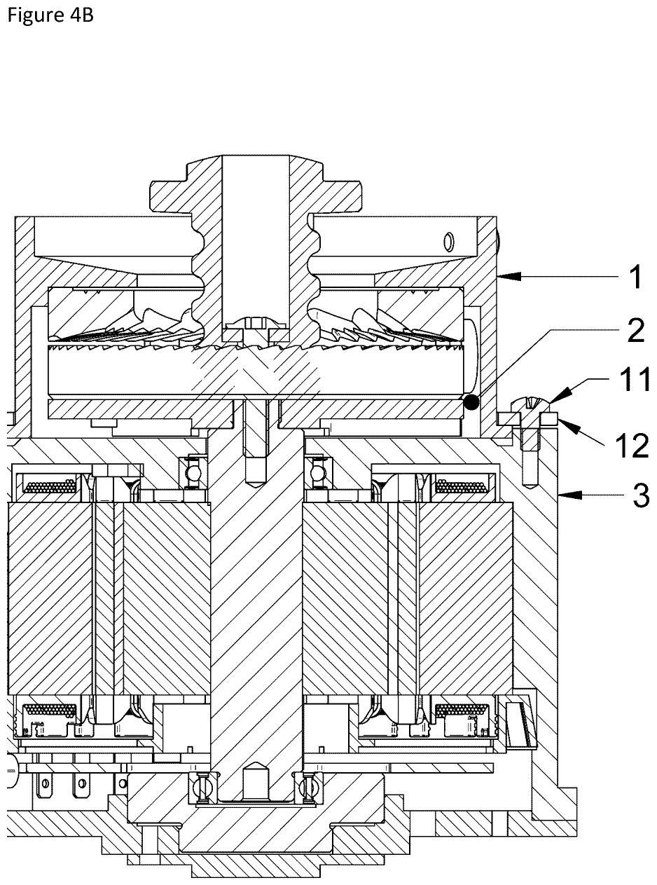

FIGS. 4A and 4B show a connection between the housing upper housing 1 to the housing lower part 3 via a clamping ring 12 for a specific coffee grinder design according to the invention. FIG. 4B shows that the clamping ring 12 is used to secure the housing upper part 1 to the housing lower part 3 via a screw connection 11. The advantage of the clamping ring 12 is that the housing upper part 1 can be turned 360° relative to the housing lower part, allowing an outlet for ground coffee located on the housing upper part to be easily and flexibly moved as required.

### LIST OF REFERENCE SIGNS

1: housing upper part;
2: interior space of housing upper part;
3: housing lower part (or a part thereof);
4: interior space of housing lower part;
5: first, upper, non-rotatable grinding disc;
6: second, lower, rotatable grinding disc;
7: brushless DC motor;
8: stator of the brushless DC motor;
9: rotor of the brushless DC motor;
10: motor shaft of the brushless DC motor;
11: screw connection;
12: clamping ring;
13: through-opening;
14: conduit;
15: screw connection;
16: bearing element to mount the motor shaft;
17: external thread of the bearing element to mount the motor shaft;
18: variable displacement motor (e.g., the coffee grinder itself);
19: gear wheel;
20: grinding disc bracket (to support the second, lower, rotatable grinding disc);
21: infeed element;
22: protective guard at infeed element
23: upper motor bearing;
24: lower engine bearing;
25: sensor to detect the degree of grinding.

1. A coffee grinder with a two-part housing, comprising:
a) a housing upper part with an interior space suitable for holding coffee beans;
b) a housing lower part, which is connected to the housing upper part and has an interior space suitable for holding a direct current (DC) motor;
c) a grinding disc arrangement that comprises or consists of a first, upper, non-rotatable grinding disc and a second, lower, rotatable grinding disc, the first grinding disc being arranged opposite the second grinding disc, the coffee grinder being configured to change a distance from the first grinding disc to the second grinding disc; and
d) a DC motor having a stator, a rotor, and a motor shaft, the motor shaft being connected to the rotor and to the second grinding disc, the stator and rotor being arranged within the interior space of the housing lower part, and the motor shaft being arranged within the housing lower part and at least in some areas within the housing upper part;
wherein the coffee grinder is configured to rotate the second grinding disc relative to the first grinding disc by moving the rotor of the DC motor.

2. A coffee grinder according to claim 1, wherein the housing upper part is connected to the housing lower part by a reversible connection.

3. A coffee grinder according to claim 1, wherein the coffee grinder has a through-opening from the coffee grinder's interior space to the coffee grinder's exterior space and is configured to convey ground coffee through the through opening.

4. A coffee grinder according to claim 1, wherein the coffee grinder has, in the housing lower part, a bearing element for mounting the motor shaft, the bearing element
i) having an external thread via which it is screwed to the housing lower part; and/or
ii) being connected to a variable displacement motor.

5. A coffee grinder according to claim 1, wherein the motor shaft of the DC motor is configured to change a position in the direction of the motor shaft's longitudinal axis.

6. A coffee grinder according to claim 1, wherein the first grinding disc and/or the second grinding disc
i) comprises or consists of a material selected from the group consisting of metal, ceramic, and combinations thereof; and/or
ii) has an external diameter in the range from 30 to 80 cm; and/or
iii) is arranged in the housing upper part.

7. A coffee grinder according to claim 1, wherein the second grinding disc
i) and the grinding disc bracket are of one piece; or
ii) is connected to a grinding disc bracket.

8. A coffee grinder according to claim 1, wherein the DC motor
i) is a DC motor equipped with brushes or a brushless DC motor, equipped housing; and/or
ii) has a wattage ranging from 50 to 500 watts; and/or
iii) has a height ranging from 25 to 70 mm, particular 40 mm; and/or
iv) has a diameter ranging from 50 to 120 mm.

9. A coffee grinder according to claim 1, wherein the coffee grinder, has a control unit that is configured to
i) control or regulate a speed frequency of the DC motor; and/or
ii) control or regulate a direction in which the rotor of the DC motor rotates.

10. A coffee grinder according to claim 9, wherein the DC motor has a rotary position sensor.

11. A coffee grinder according to claim 10, wherein the housing upper part and/or the housing lower part
i) has at least a wall thickness ranging between 1 and 5 mm in some areas; and/or
ii) comprises or consists of a material selected from the group consisting of metal, plastic, and combinations thereof; and/or
iii) has a height ranging from 50 to 150 mm; and/or
iv) has a diameter ranging from 50 to 150 mm; and/or
v) has a shape of a hollow cylinder at least in some areas.

12. A coffee machine comprising a coffee grinder according to claim 1.

13. A coffee machine according to claim 12, wherein the DC motor of the coffee grinder of the coffee machine has a rotary position sensor.

14. A method to grind coffee in a coffee grinder, comprising the steps of:
a) providing a coffee grinder according claim 1;
b) filling the housing upper part of the coffee grinder with coffee beans or coarsely ground coffee; and
c) grinding the coffee beans or coarsely ground coffee.

15. A method according to claim 14, wherein the DC motor has a rotary position sensor, and, based on at least one signal of the rotary position sensor,
i) a speed frequency of the DC motor is regulated; and/or
ii) a direction in which the rotor of the DC motor rotates is regulated; and/or
iii) a blockage of the DC motor is detected and, in the event that a blockage is detected, a direction in which the DC motor rotates is reversed for a specific period of time, and/or for a specific degree of rotation; and/or
iv) a grinding point of the first grinding disc on the second grinding disc is detected and, in the event a grinding point is detected, the grinding point is used as a setting for the coffee grinder's finest grind;

16. A method to grind coffee in a coffee grinder, comprising the steps of:
a) providing a coffee machine according to claim 12;
b) filling the housing upper part of the coffee grinder with coffee beans or coarsely ground coffee; and
c) grinding the coffee beans or coarsely ground coffee.
